(19) United States
(12) Patent Application Publication
(10) Pub. No.: US 2005/0057055 A1
(43) Pub. Date: Mar. 17, 2005

(54) Tool for picking up clothes off the floor

(76) Inventor: Darlene Deal, North Hollywood, CA (US)

Correspondence Address: Darlene Deal, Post Office Box 521, North Hollywood, CA, 91603-0521, US

(21) Appl. No.: 10/664,086

(22) Filed: Sep. 17, 2003

(51) Int. Cl. B25J 1/02

(52) U.S. Cl. 294/19.1

(57) ABSTRACT

A cloth picking up tool for lifting the clothes located on the floor or similar lower surfaces to higher surface by means of grabbing, lifting and releasing the clothes includes a first member attached to the trigger on one side and having at least three members pivotally connected to other side and a second member attached to the handle on one side and having at least three openings on other side which the three members that are pivotally connected to the first member goes through, thereof guiding the opening apart and closing together of the at least three members pivotally connected to the first member as the first member is moved along the axis of the second member by means of bringing the trigger attached to the first member and the handle attached to the second member together and apart. An adjustable and removable elbow-supporting member is attached to the handle providing the operator with better leverage. A trigger lock member locks the trigger and handle in their position while they are squeezed together.

### BACKGROUND OF THE INVENTION

Present invention is directed to picking up clothes that are located on the lower surfaces such as floor. The department stores often place large quantities of clothes on the floor during their sales. Also many costumers drop clothes on the floor while they shop. These clothes have to be picked up during and at the end of the work day by the workers of the store, causing the workers repeatedly stoop and bend many times to pick up the clothes off the floor. Workers pick up the clothing pieces dropped by the customers and hang them back to their places, they also pick up the big loads of sale clothes and move them out of side. This excessive bending causes back pains for the workers making it very hard for them to pick up these clothes of the floor.

### SUMMARY OF THE INVENTION

Present invention allows the operator to pick up the clothes described in the BACKGRAOUND OF THE INVETION without having to bend or stoop. The invention allows the operator to use his or her arm to pick up these clothes from a standing position. The invention is a lightweight pick up tool that can pick up one or many clothes at once. The workers of the department stores can use this invention to pick up big loads of clothing left on the floor after a sale by grabbing and lifting multiple clothes at once, or they can use this invention to pick up single clothing piece dropped by the costumers.

There are many pick up tools designed to retrieve objects of the ground, the present invention is different from the existing pick up tools in many ways. The adjustable and removable elbow support of the present invention allows the operator to use his or her entire upper arm strength as well as his or her wrist and hand strength, while the existing pick up tools only make use of the wrist and hand strength of the operator. The existing pick up tools require the wrist muscles to handle all the weight, which is the weight of the pick up tool and the object being retrieved, while bringing the object to desired elevation, while the present invention mostly uses the upper arm bicep muscles to bring the object or objects to desired elevation. This difference allows the present invention to lift heavier loads than the existing pick up tools can. The ability to lift heavier loads allows the operator to pick up bigger loads of clothing of the floor, thus minimizing the number of times the pick up procedure needs to be repeated to pick up all the clothes off the floor when the operator is to pick up a big load of clothes off the floor, which is the case at department stores at the end of sale day. The gripping members of the present invention apply more force as they close their grip, while the operator applies a constant force to bring the handle and the trigger together, which makes is it easier for the operator to bring together loosely spaced clothes while the grip is relatively open and grab the clothes by compressing them more while the grip is relatively close. The present invention has three grip members, while the existing pick up tools only have two. The present invention can be left at rest on its three grip members with the grip members open, the invention would stay standing up vertically with the handle on its higher end, the grip members act as the legs on its lower end that the invention stands on, none of the existing pick up tools have this ability. The present inventions ability to stand on its own, allows the operator to pick up a piece of clothing of the floor and just leave the present invention standing on it own, thus having the use of both of his or her hands to hang back the piece of clothing he or she has just picked up. After hanging back the clothing operator can pick up the present invention easily since the handle of the present invention would be standing around the operators waist height, making the handle very easily accessible. This way the workers of the department store can rapidly and easily pick up the clothing pieces and hang them using both of their hands with out having the bend over at all. Thus the present invention can save time and effort for the department store workers.

The present invention has a trigger lock to lock the trigger when the grip is in a closed position, which allows the operator to lock the grip closed and store the invention where the invention takes less storage place. It also allows the operator to lock the grip closed while there are clothes in the grip and carry the clothes to further distances without having to keep squeezing the trigger and the handle together.

Other people such as people who don't want to bend over, people with medical problem that shouldn't bend over and the like can also use the present invention to pick up various objects that need to be retrieved.

### BRIEF DESCRIPTION OF THE SEVERAL VIEWS OF THE DRAWING

FIG. 1 is a perspective view of the tool for picking up clothes off the floor in a closed condition.

FIG. 2 is a perspective view of the tool for picking up clothes off the floor in an open condition.

FIG. 3 is a perspective view of the exploded handle assembly.

FIG. 4 is a perspective view of the exploded grip mechanism assembly.

FIG. 5 is a section view of the handle in an open condition taken along the line VI-VI in FIG. 2

FIG. 6 is a section view of the grip mechanism in an open condition taken along the line VI-VI in FIG. 2

FIG. 7 is a section view of the handle in a closed condition taken along the line VI-VI in FIG. 2

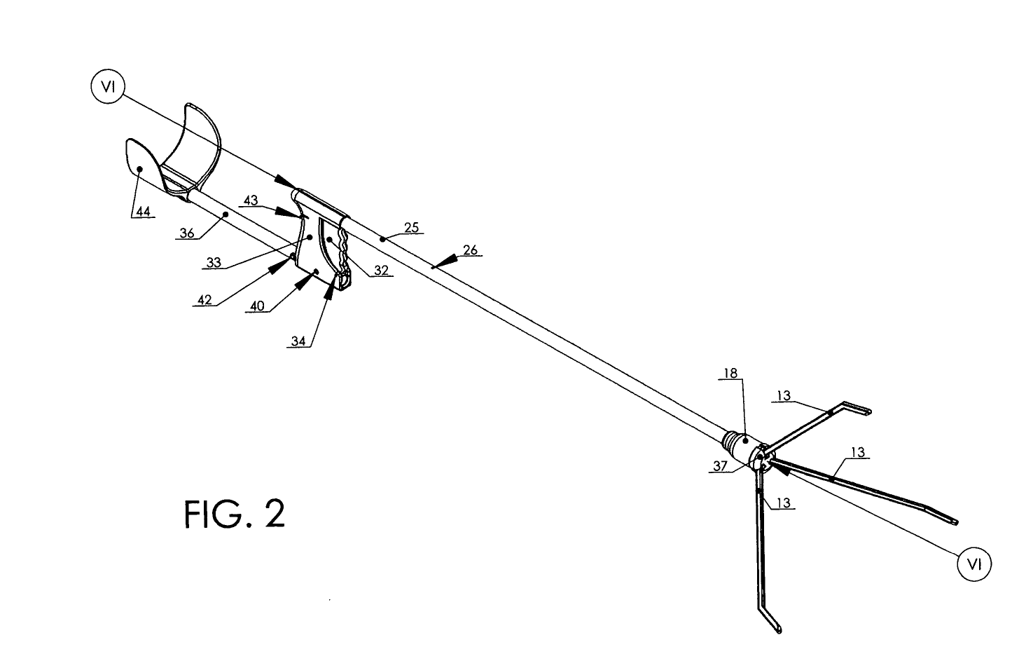

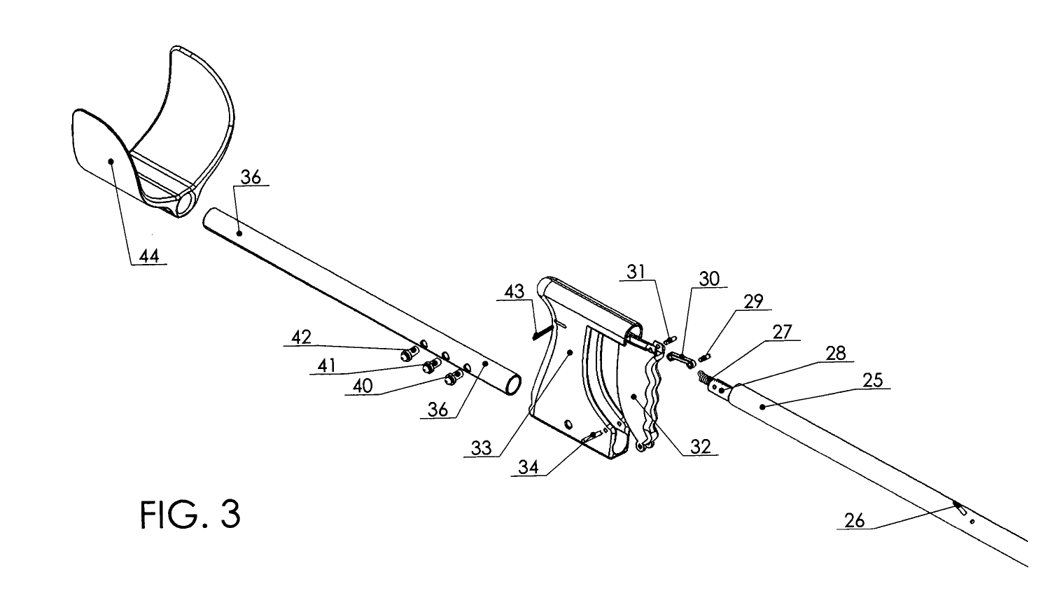

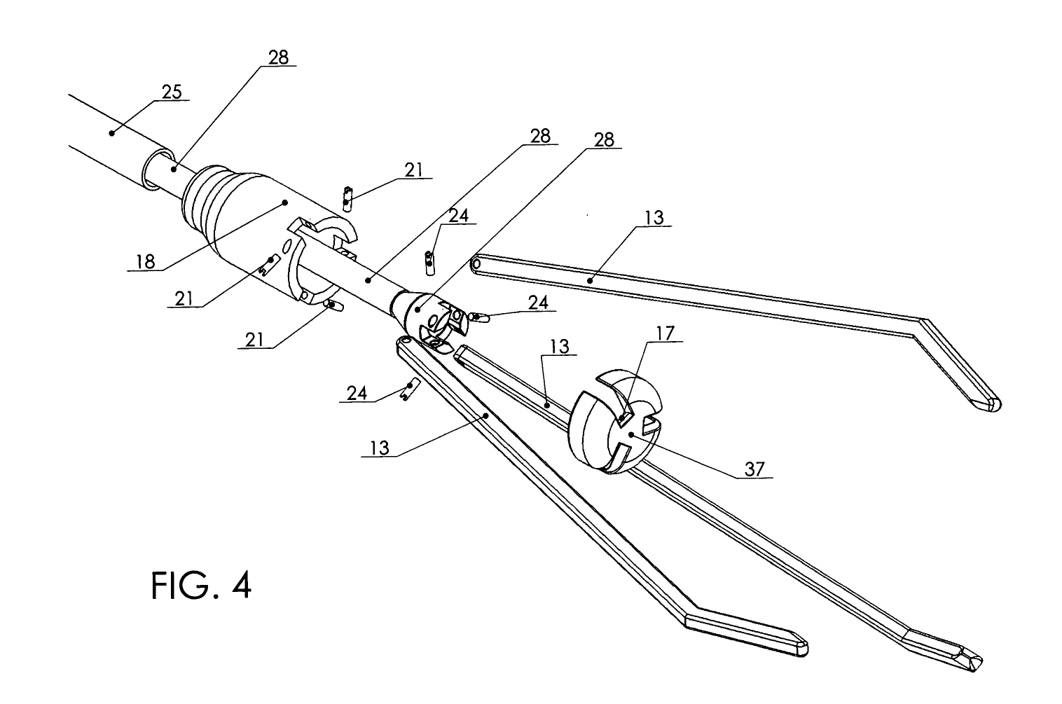

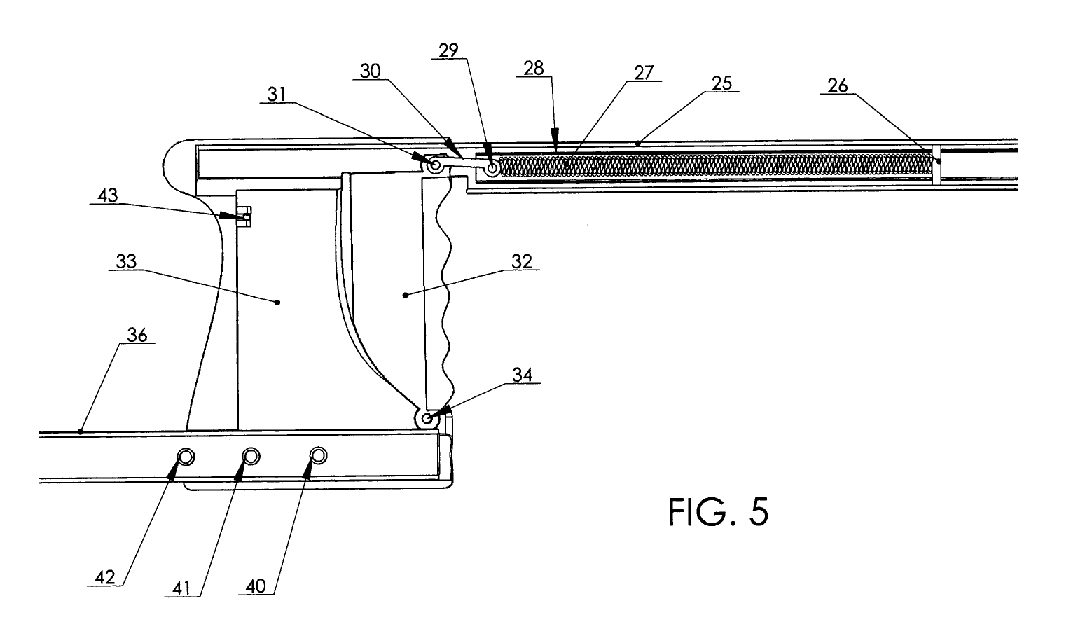

FIG. 5 is a section view of the grip mechanism in a closed condition taken along the line VI-VI in FIG. 2

### DETAILED DESCRIPTION OF THE INVENTION

The tool for picking up clothes off the floor according to the present invention is designed for grabbing, lifting, moving and releasing clothes located on the lower surfaces such as floor and the like without the operator bending over to reach down is comprised of at least three members for gripping clothes 13 pivoted to a shaft member 28 by means of pivot members 24, the shaft member 28 is pivoted to the connecting member 30 by means of a pivoting member 29, the connecting member 30 is pivoted to the trigger member 32 by means of a pivot member 31, the trigger member 32 is pivoted to the handle member 33 by means of a pivot member 34, the handle member 33 is connected fixed to the body member 25, the body member 25 is connected to the closing member 18, the closing member 18 is connected to the opening member 37. As shown in FIGS. 5, 6, 7 and 8

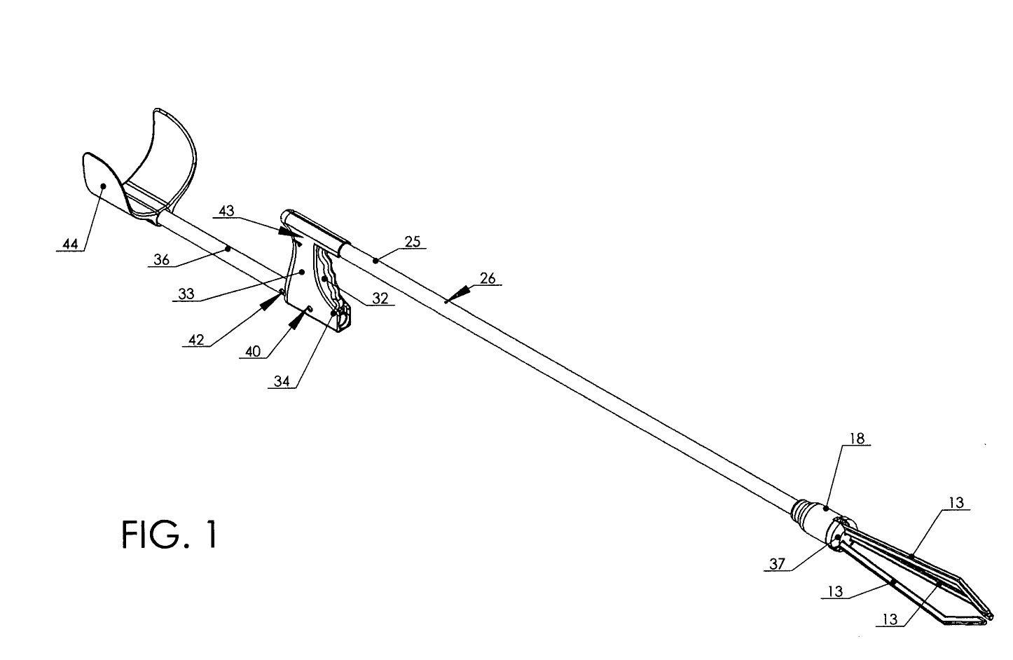

Upon squeezing the handle member 33 and the trigger member 32 together, the connecting member 30 moves away from the opening member 37, which then moves the shaft member 28 away from the opening member 37 and into the closing member 18 along the shaft member 28 axis pulling the three members for gripping clothes 13 into the grip closing member 18, the members for gripping clothes 13 are pushed towards each other by three pins 21 attached to the closing member 18, thus closing the members for gripping clothes 13 together and compressing the clothes in between the members for gripping clothes 13 as the trigger member 32 and handle member 33 are squeezed together. As shown in FIGS. 1, 7 and 8

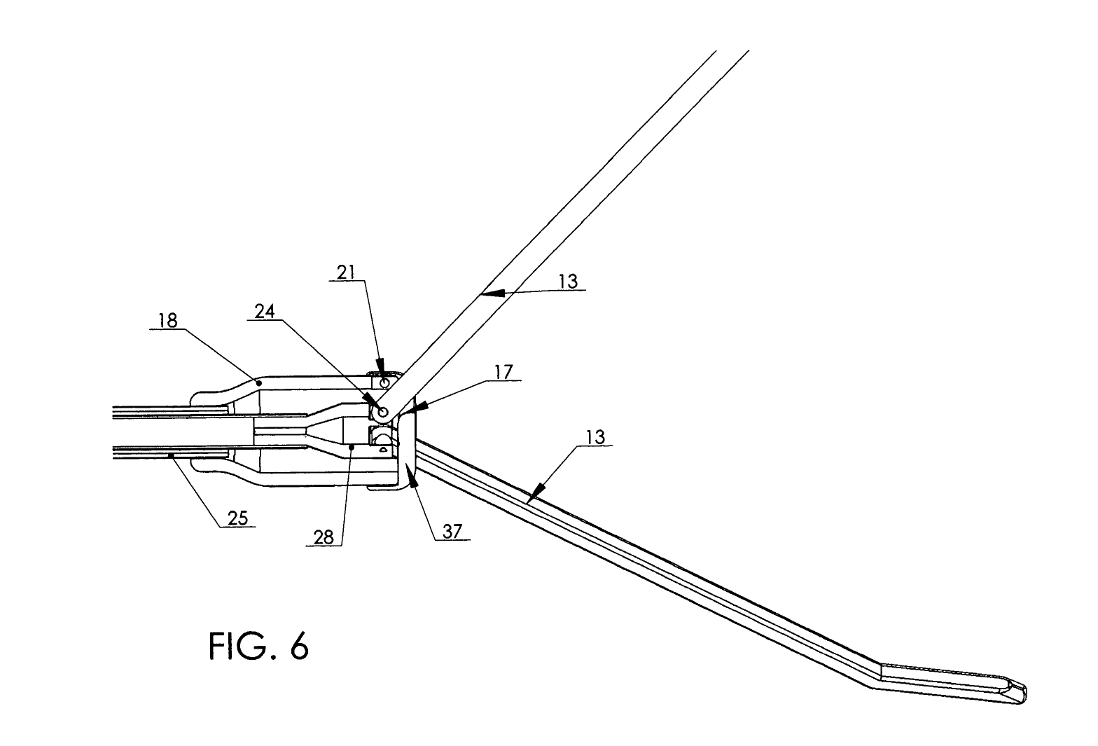

Due to the unique closing and opening mechanism of the members for gripping clothes 13, when a constant squeezing force is applied to handle member 32 and the trigger member 33 to close the grip members 13 towards each other, the compression force exerted by each of the members for gripping clothes 13 towards each other increases equally with an increasing rate as the members for gripping clothes 13 come closer towards each other. Thus the gripping force exerted by the members for gripping clothes 13 starts from minimum amount of force when they are furthest away from each other and reaches to maximum amount of force when they are completely closed towards each other. As shown in FIGS. 6 and 8

Upon releasing the handle member 33 and the trigger member 32, the extension spring 27 connected to the shaft member 28 by means of the pivot member 29 and to the body member 25 by means of the pin member 26 pulls the handle member 33 and the trigger member 32 apart and pulls the trigger member 32 towards the opening member 37, then the trigger member 32 pushes the shaft member 28 towards the opening member 37, then the shaft member 28 pushes the members for gripping clothes 13 toward the opening member 37, then the faces 17 of the opening member 37 pushes the members for gripping clothes 13 apart from each other and away from each other, thus opening the members for gripping clothes 13 apart, thus releasing the clothes that are compressed between the members for gripping clothes 13. As shown in FIGS. 2, 5 and 6

An adjustable and removable elbow support member 36 is attached to the handle member 33. The elbow support member 36 is locked in to its position with the handle member 33 by means of one of the release buttons 40, 41 or 42. The elbow support member can be moved along its axis until the next release button 40, 41 or 42 locks into place or it can be removed completely or it can be removed then turned around then locked to its position in the opposite direction it was originally facing so that it is still attached to the handle member 33 while it is not being used. As shown in FIGS. 1 and 2

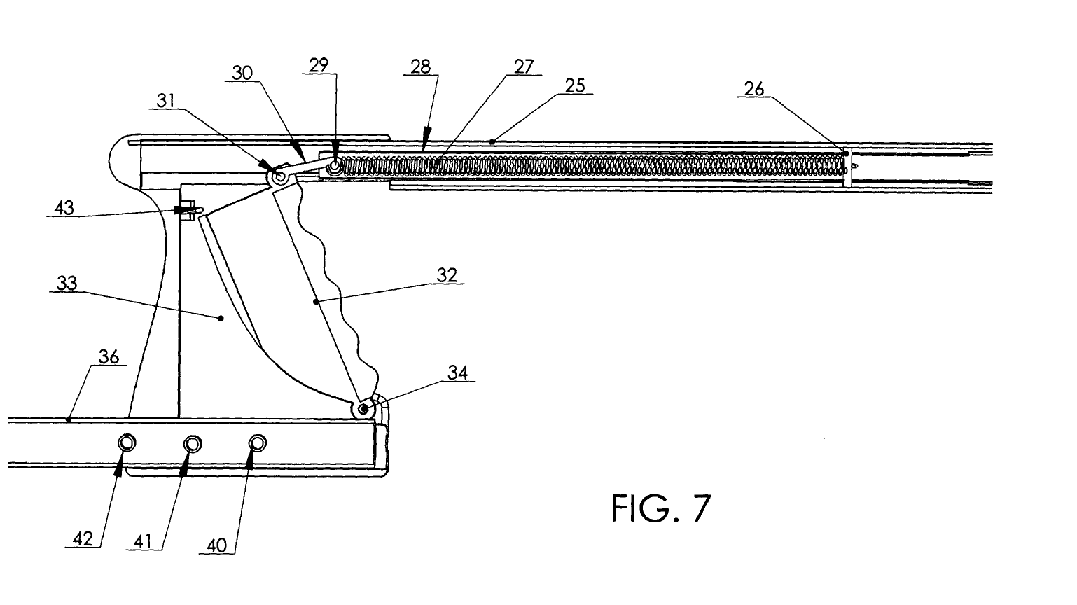

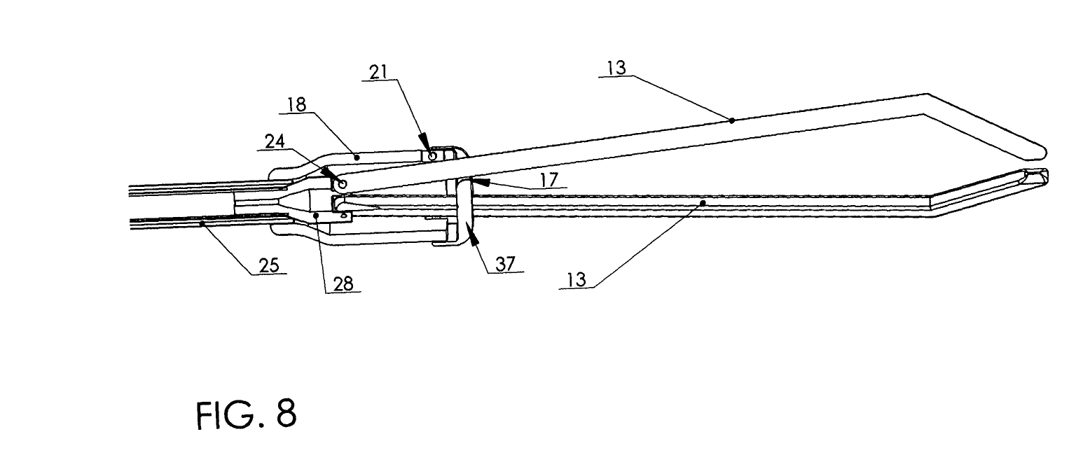

A trigger lock pin member 43 locks the trigger member 32 into a set position with respect to the handle member 33 when the trigger member 32 and the handle member 33 are squeezed together. Upon moving the trigger lock pin member 43 towards the trigger member 32 while trigger member 32 and the handle member 33 are squeezed together, then releasing the trigger member 32 and the handle member 33, lock is activated. Upon squeezing the trigger member 32 and the handle member 33 together while the trigger is locked the lock is released. As shown in FIG. 5 and 7

When it is necessary to pick up large quantities of clothing of the floor or such lower surfaces the present invention may be used to pick up the clothes without the operator having to bend over to reach down. The members for gripping clothes 13 are placed over and around the clothes to be picked up, then the trigger member 32 and handle member 33 are squeezed together thus the clothes are compressed in between the members for gripping clothes 13, then the clothes are moved to the desired location by using the elbow support member 36 to gain leverage, then the trigger member 32 and the handle member 33 are released thus the clothes compressed between the members for gripping clothes 13 are released. The operation may be repeated until all the clothes are moved. Also the operator can lock the trigger in position while the trigger member 32 and the handle member 33 are squeezed together and move further distances while the clothes are compressed in between the members for gripping clothes 13 without having to keep squeezing the trigger member 32 and the handle member 33 together during the time it takes the operator move the further distance.

When it is necessary to pick up a single piece of clothing and hang it on to its original location, the operator can perform a regular pick up as described earlier to retrieve the clothing of the floor and then the operator can leave the present invention on its members for gripping clothes 13, while the trigger is released as seen in FIG. 2, where the members for gripping clothes 13 act as the legs to hold the present invention vertically with the handle 33 approximately resting at the height of the operators hip. By leaving the present invention to stand on its own the operator is able to use both of his or her hands to hang the retrieved piece of clothing to its original location. After hanging back the clothing the operator can easily pick up the present invention since the handle 33 is resting at the same level with the operators' hand when the operators' arm is hanging down freely from shoulder. The operator can repeat the process as necessary until all the desired clothing is picked up and hung.

The connections between the members that are fixed with each other can be made by gluing with a suitable bonding material. The pins and the pins acting as pivot members can be screwed to their places. The material for the components such as the body member 25, the shaft member 28, the elbow support member, the connecting member 30, the closing member 18, the opening member 37 and the members for gripping clothes 13 may be built of aluminum or hard plastic that can handle the stress or any other material that is like wise in weight and strength. The pins 21 may be built of stronger material such as steel, since they will be used extensively to compress the clothes being moved. The pins 21 may be coated with a surface that has a low friction coefficient or bearings may be added around the pins 21 to minimize friction. Also the tip of the members for gripping clothes 13 may be covered with plastic material or like to prevent them from scratching the surfaces they work on such as wood floors or like.

1- A tool for picking up clothes off the floor comprising:
a handle to be engaged by the palm of the operator,
a trigger to be engaged by the fingers of the operator, connected to the said handle at its end corresponding to the pinky end of the palm of the operator by means of a pivoting member, allowing the trigger move towards and away from the handle,
a tube body fixed to the said handle,
at least three grip members,
a shaft tube connected to the said trigger on the higher end by means of a pivoting member and to at least three said grip members on the lower end by means of pivoting members, so that the grip members can move towards and away from each other,
a grip closer connected to the end of the said body tube to push the said grip members toward each other as the lower end of said the shaft tube the said grip members are attached to moves in to the said grip closer as the said handle and the said trigger are brought together by the operator,
a grip opener connected to the said grip closer to push the said grip members away from each other as the lower end of the said shaft tube the said grip members are attached to moves towards the said grip opener as the said trigger and said handle are released from their together position,
an extension spring connected to the said shaft tube and the said body tube, bringing the said trigger away from the said handle, thus bringing the said shaft tube closer to the said grip opener, thus opening the said grip members away from each other,
a length adjustable, removable elbow support connected to the bottom of the said handle to support the elbow of the operator,
a trigger lock accessible by the thumb of the operator connected to the said handle to lock the said trigger and the said handle in position while they are squeezed together

2- the device described in claim 1, where the said elbow support allows the operator to use mostly upper arm muscles including the operators' bicep and chest muscles as well as the wrist and hand muscles instead of just hand and wrist muscles, also providing the operator with extra leverage due to the additional wrist to elbow distance gained.

3- the device described in claim 1, where the said grip members in an open position with the handle released, supply the legs for the said tool to stand on at a vertical rest with the said handle being at rest around the same height with the operators hip, thus allowing the said tool to stand on its own on any horizontal and nearly horizontal surface while its easily accessible to be picked up again by the operator.

4- the device described in claim 1, where the said grip members apply varying force with an increasing rate towards each other as they get closer to each other when the said trigger and the said handle are squeezed together by means of a constant force.

5- the device described in claim 1, where the pivoting point of the said trigger is further away from the index finger of the operator and closer to the pinky finger of the operator, providing the weaker fingers with less leverage and the stronger fingers with more leverage, thus minimizing the use of pinky finger squeezing force while maximizing the use of the index and the middle fingers squeezing force, thus providing the operator with a bigger total force as a product of squeezing the said handle and the said trigger together.
